(19) United States
(12) Patent Application Publication
(10) Pub. No.: US 2018/0031902 A1
(43) Pub. Date: Feb. 1, 2018

(54) ELECTRO-OPTICAL DEVICE AND ELECTRONIC APPARATUS

(71) Applicant: SEIKO EPSON CORPORATION, Tokyo (JP)

(72) Inventors: Suguru UCHIYAMA, Suwa-shi (JP); Nariya TAKAHASHI, Chino-shi (JP); Hiroyuki HOSAKA, Matsumoto-shi (JP)

(73) Assignee: SEIKO EPSON CORPORATION, Tokyo (JP)

(21) Appl. No.: 15/640,843

(22) Filed: Jul. 3, 2017

(30) Foreign Application Priority Data
Jul. 26, 2016 (JP) 2016-146025

(51) Int. Cl. G02F 1/1333; G02F 1/1345; G09G 3/36; G02F 1/133; G02F 1/1343

(52) U.S. Cl. CPC G02F 1/133385; G02F 1/13306; G02F 1/134336; G09G 3/3611; G02F 1/13452; G09G 2330/045; G09G 2310/08; G02F 2201/123

(57) ABSTRACT

An electro-optical device includes a liquid crystal panel that is an example of an electro-optical panel, a first wiring board one end of which is connected to the liquid crystal panel, a second wiring board one end of which is connected to the liquid crystal panel at a position in a Y-axis direction viewed from the one end of the first wiring board and which has a shape bent in an X-axis direction, a first driving circuit that is provided on the first wiring board and drives the liquid crystal panel, and a second driving circuit that is provided in the bent part of the second wiring board and drives the liquid crystal panel.

### BACKGROUND

### 1. Technical Field

The present invention relates to an electro-optical device and an electronic apparatus.

### 2. Related Art

In an electro-optical device that is provided with a liquid crystal electro-optical panel and the like, the processing load of a driving circuit (driving IC) that drives the electro-optical panel increases in accordance with an increase and the like of the number of pixels. Thereby, it is possible to cause the heat that is generated by the driving circuit to increase. In contrast, JP-A-2010-102219 describes fixing the driving circuit on a flexible substrate to a heat dissipation member with a configuration in which the flexible substrates are connected to the respective terminal of each row of a plurality of rows. JP-A-2009-75457 describes disposing the heat dissipation member so as to overlap an integrated circuit on a wiring board.

In the technology in JP-A-2010-102219, a plurality of flexible substrates almost entirely overlap each other and also overlap the driving circuit. Therefore, dissipation of heat that is generated by the driving circuit on one flexible substrate tends to be hindered by another flexible substrate, and dissipation of heat is not sufficient due to the increased load on the driving circuit. JP-A-2009-75457 does not describe connecting a plurality of wiring boards to an electro-optical panel.

### SUMMARY

An advantage of some aspects of the invention is to provide a technology for effectively dissipating heat that is generated by the driving circuit which is provided on each wiring board of the plurality of wiring boards.

According to an aspect of the invention, there is provided an electro-optical device including an electro-optical panel, a first wiring board, one end of which is connected to the electro-optical panel, a second wiring board, one end of which is connected to the electro-optical panel at a position in a first direction from the one end of the first wiring board and which is shaped to be bent in a second direction that is different from the first direction, a first driving circuit that is provided on the first wiring board and drives the electro-optical panel, and a second driving circuit that is provided in a bent part of the second wiring board and drives the electro-optical panel.

In the electro-optical device of the aspect of the invention, the second wiring board has one end which is positioned on a side in a first direction from the one end of the first wiring board, and a part bent in a second direction that is different from the first direction. The driving circuit of the second wiring board is provided in the bent part. Consequently, according to the aspect of the invention, the heat that is generated by the driving circuit is able to be effectively dissipated.

In the aspect of the invention, a heat dissipation member that is disposed at a position which covers the first driving circuit and the second driving circuit may be provided.

According to the aspect of the invention, it is possible to facilitate dissipation of heat from a first driving circuit and a second driving circuit by using the heat dissipation member.

In the aspect of the invention, the heat dissipation member may be disposed at a position which covers the first driving circuit and the second driving circuit from one surface side and the other surface side of the first wiring board and the second wiring board.

According to the aspect of the invention, it is possible to further facilitate dissipation of heat from the first driving circuit and the second driving circuit by using the heat dissipation member that is disposed on the one surface side and the other surface side of the first wiring board and the second wiring board.

In the aspect of the invention, there may be provided a third driving circuit that is provided at a position not overlapping the first driving circuit on the first wiring board and that drives the electro-optical panel and a fourth driving circuit that is provided at a position not overlapping the second driving circuit on the bent part and that drives the electro-optical panel.

According to the aspect of the invention, dissipation of heat that is generated by each driving circuit is efficient compared with a case in which the first wiring board, the second wiring board, the third wiring board, and the fourth wiring board overlap each other and the driving circuits that are provided on the wiring boards overlap each other.

The aspect of the invention is able to be conceived as an electronic apparatus other than the electro-optical device.

### BRIEF DESCRIPTION OF THE DRAWINGS

The invention will be described with reference to the accompanying drawings, wherein like numbers reference like elements.

FIG. 1 is a perspective view illustrating a configuration of an electro-optical device according to a first embodiment of the invention.

FIG. 2 shows a front surface view and a rear surface view of the electro-optical device according to the embodiment.

FIG. 3 is a front surface view of a liquid crystal panel according to the embodiment.

FIG. 4 is a diagram illustrating the liquid crystal panel in a state in which a second wiring board is connected according to the embodiment.

FIG. 5 is a diagram illustrating the liquid crystal panel in a state in which a first wiring board and the second wiring board are connected according to the embodiment.

FIG. 6 is a sectional view (sectional view VI-VI in FIG. 1) when the electro-optical device is cut away along an X-axis according to the embodiment.

FIG. 7 is a perspective view illustrating a configuration of an electro-optical device according to a second embodiment of the invention.

FIG. 8 shows a front surface view and a rear surface view of the electro-optical device according to the embodiment.

FIG. 9 is a front surface view of a liquid crystal panel according to the embodiment.

FIG. 10 is a diagram illustrating the liquid crystal panel in a state in which a fourth wiring board is connected according to the embodiment.

FIG. 11 is a diagram illustrating the liquid crystal panel in a state in which a third wiring board is connected according to the embodiment.

FIG. 12 is a diagram illustrating the liquid crystal panel in a state in which a second wiring board is connected according to the embodiment.

FIG. 13 is a diagram illustrating the liquid crystal panel in a state in which a first wiring board is connected according to the embodiment.

FIG. 14 is a sectional view (sectional view XIV-XIV in FIG. 7) when the electro-optical device is cut away along the X-axis according to the embodiment.

FIG. 15 is a front surface view of an electro-optical device according to a third embodiment of the invention.

FIG. 16 is a sectional view (sectional view XVI-XVI in FIG. 15) when the electro-optical device is cut away along a Y-axis according to the embodiment.

FIG. 17 is a sectional view (sectional view XVII-XVII in FIG. 15) when the electro-optical device is cut away along the Y-axis according to the embodiment.

FIG. 18 is a diagram illustrating a projector to which the electro-optical device of the invention is applied.

### DESCRIPTION OF EXEMPLARY EMBODIMENTS

Embodiments of the invention will be described below with reference to the drawings. In each drawing referred to in the description below, the scale may be different from the actual scale in order for each member, each region, and the like to be recognizable sizes.

### First Embodiment

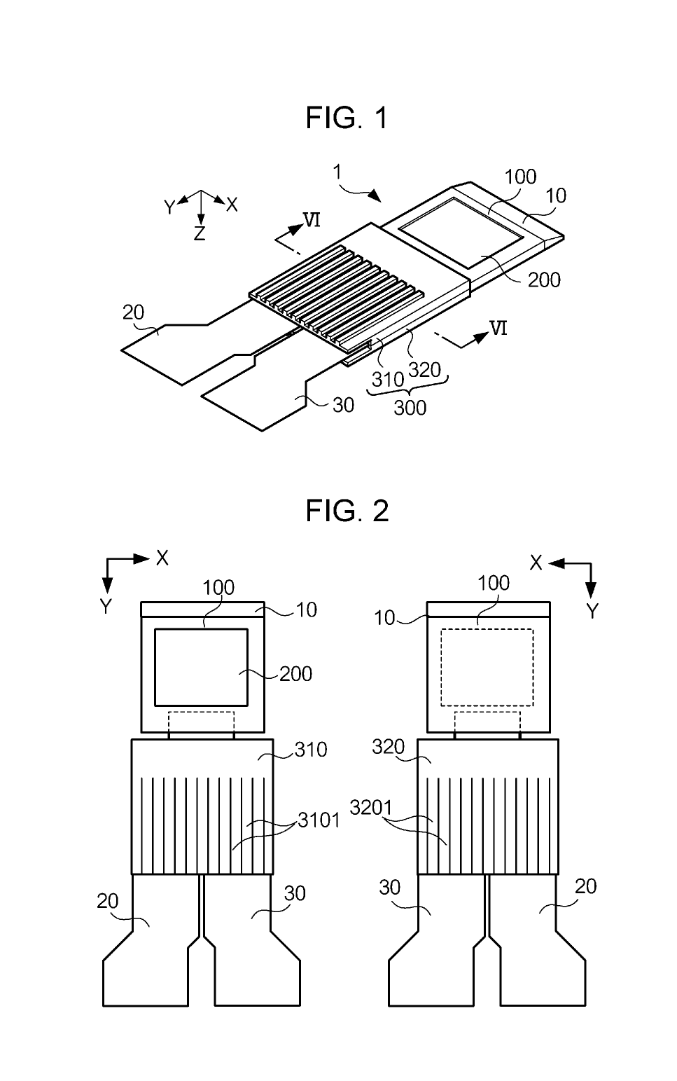

FIG. 1 is a perspective view illustrating a configuration of an electro-optical device 1 according to a first embodiment. FIG. 2 shows a front surface view and a rear surface view of the electro-optical device 1. In the description below, each direction is represented using an orthogonal coordinate system that consists of an X-axis, a Y-axis, and a Z-axis indicated in FIG. 1. The X-axis and the Y-axis extend in a direction parallel to one side of a pixel region 200, which has a rectangle shape. The Z-axis extends in a direction corresponding to a line of sight when viewing a liquid crystal panel 100 from a front surface. A direction from the front surface to a rear surface of the liquid crystal panel 100 is a positive Z-axis direction, and a direction from the rear surface to the front surface is a negative Z-axis direction.

The electro-optical device 1 is the liquid crystal display apparatus in the embodiment. The electro-optical device 1 is provided with the liquid crystal panel 100, a casing 10, a first wiring board 20, a second wiring board 30, and a heat dissipation member 300. The liquid crystal panel 100 is accommodated in an open frame-shaped casing 10 in a display portion that corresponds to the pixel region 200 and is connected to one end of each of the first wiring board 20 and the second wiring board 30. For example, the heat dissipation member 300 is formed using metal and has a shape that covers a part of the first wiring board 20 and the second wiring board 30. The heat dissipation member 300 is provided in order to dissipate heat that is generated in the first wiring board 20 and the second wiring board 30. The heat dissipation member 300 is configured to include a first heat dissipation member 310 that covers the first wiring board 20 and the second wiring board 30 from the front surface side and a second heat dissipation member 320 that covers the first wiring board 20 and the second wiring board 30 from the rear surface side. In addition, the heat dissipation member 300 is constituted to cover a first driving circuit 22 and a second driving circuit 32, which are driving circuits described later. A plurality of fins 3101 for facilitating heat dissipation are disposed on a surface on the front surface side of the first heat dissipation member 310, and a plurality of fins 3201 for facilitating heat dissipation are disposed on a surface on the rear surface side of the second heat dissipation member 320.

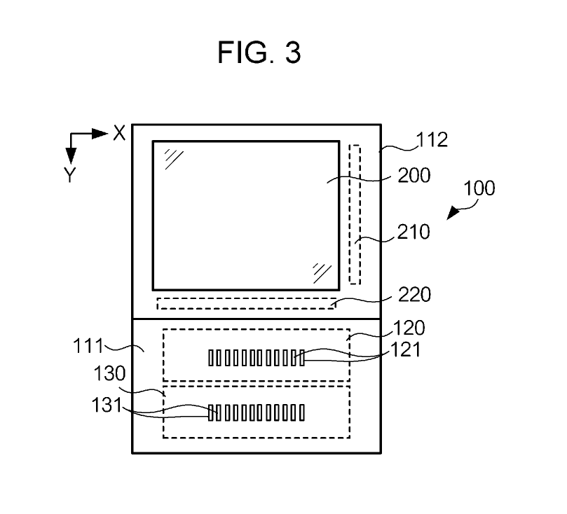

FIG. 3 is a front surface view of the liquid crystal panel 100. The liquid crystal panel 100 in a state in which the casing 10, the first wiring board 20, the second wiring board 30, and the heat dissipation member 300 are removed is shown in FIG. 3.

The liquid crystal panel 100 is an example of an electro-optical panel that performs an electro-optical operation, and here, the liquid crystal panel 100 is a transmissive liquid crystal panel. The electro-optical operation includes a display operation that displays images in the pixel region 200. The liquid crystal panel 100 is constituted such that an element substrate 111 on which a plurality of pixel electrodes (not shown) are formed and a counter substrate 112 on which a common electrode (not shown) is provided are pasted maintaining a fixed gap, and for example, in the gap, a vertical alignment (VA) type liquid crystal is disposed. Each of the element substrate 111 and the counter substrate 112 is formed by elements that have optical transparency, such as glass and quartz.

The pixel region 200 is formed on a surface of the element substrate 111 which faces the counter substrate 112. Here, the pixel region 200 is a region that includes a plurality of pixels. Specifically, the pixel region 200 is formed by a plurality of pixel electrodes that are arranged in a matrix shape, and the pixel electrodes are disposed to correspond to each point of intersection of a scanning line of a plurality of rows that extend in the X-axis direction, which is equivalent to a row direction, and a data line of a plurality of columns that extend in the Y-axis direction, which is equivalent to a column direction. The Y-axis direction is equivalent to the first direction and the X-axis direction is equivalent to the second direction. A scanning line driving circuit 210 is provided along one side of a peripheral region of the pixel region 200 on the element substrate 111, on the surface of the element substrate 111 which faces the counter substrate 112. The scanning line of a plurality of rows of the pixel region 200 is connected to the scanning line driving circuit 210. A data line selection circuit 220, a first terminal group 120, and a second terminal group 130 are formed on another side that is orthogonal to a side on which the scanning line driving circuit 210 is provided. The liquid crystal panel 100 of the embodiment is driven by two driving circuits consisting of the first driving circuit 22 and the second driving circuit 32 according to the number of data lines, as well as the capacity of a data line selection circuit 220 and the driving circuits. A driving signal which drives the liquid crystal panel 100 is supplied via the first terminal group 120 and the second terminal group 130. The driving signal includes various signals or various voltages. The scanning line driving circuit 210 performs scanning line driving that supplies a scanning signal to each scanning line of a plurality of rows as an example of driving according to the signal and the voltage. In addition, the data line selection circuit 220 selects each data line of the plurality of columns and performs data line driving that supplies a data signal to pixels for displaying images in the pixel region 200 according to the data signal and a timing signal that are included in the driving signal. The liquid crystal panel 100 of the embodiment is able to drive double the number of data lines that are able to be driven by one driving circuit, and in addition, a compact high-definition liquid crystal panel 100 is configured without widening the size (width) of the liquid crystal panel 100 in the X-axis direction by disposing the first terminal group 120 and the second terminal group 130 in the Y-axis direction. Note that, in the following drawings, description of the data line selection circuit 220 and the scanning line driving circuit 210 is omitted.

The first terminal group 120 includes a plurality of first terminals 121 that are arranged in the X-axis direction. The first terminal group 120 is positioned further than the data line selection circuit 220 from the pixel region 200 and is separated from the pixel region 200, and specifically, is positioned on the end portion of the element substrate 111 in the Y-axis direction. The plurality of first terminals 121 include a terminal to which the data signal and the timing signal are input, and are connected to the data line selection circuit 220. At least the plurality of first terminals 121 to which the data signal is input are the same shape and have the same dimensions as in the embodiment and are rectangular when viewed in the Z-axis direction. In addition, at least the plurality of first terminals 121 to which the data signal is input are arranged at an equal pitch in the embodiment.

The second terminal group 130 includes a plurality of second terminals 131 that are arranged in the X-axis direction. The second terminal group 130 is positioned further than the first terminal group 120 from the pixel region 200 and is separated from the pixel region 200, and specifically, is positioned further on the end portion of the element substrate 111 in the Y-axis direction than the first terminal group 120. The plurality of second terminals 131 include a terminal to which the data signal and the timing signal are input, and are connected to the data line selection circuit 220. At least the plurality of second terminals 131 to which the data signal is input are the same shape and have the same dimensions as in the embodiment and are rectangular when viewed in the Z-axis direction. In addition, at least the plurality of second terminals 131 to which the data signal is input are arranged at an equal pitch in the embodiment. In the embodiment, the first terminal group 120 and the second terminal group 130 have the same position in the X-axis direction as one set of the first terminal 121 and the second terminal 131.

Note that, the number of terminals that are included in the first terminal group 120 and the second terminal group 130 is specified according to the number of data lines and the capacities of the data line selection circuit 220, the first driving circuit 22, and the second driving circuit 32.

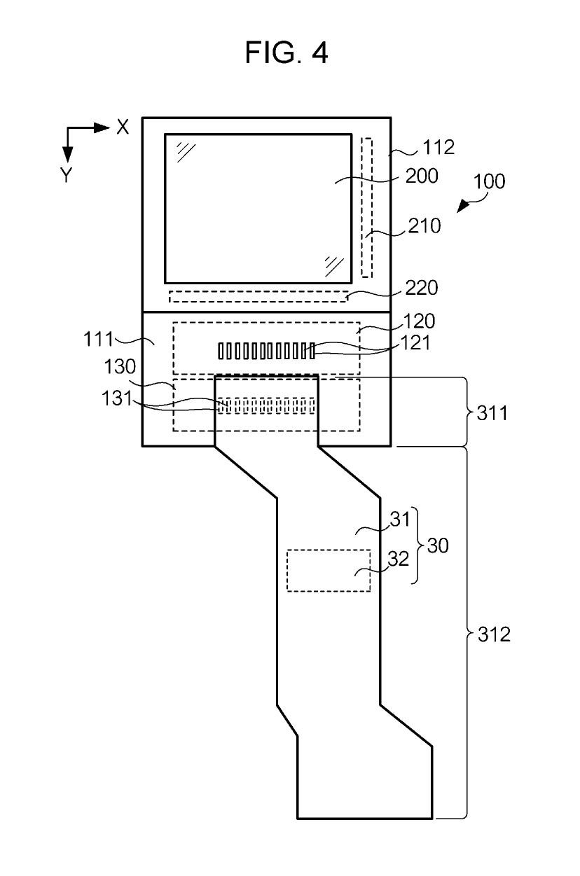

The first wiring board 20 is connected to the plurality of first terminals 121 of the first terminal group 120, and the second wiring board 30 is connected to the plurality of second terminals 131 of the second terminal group 130. During connection of the liquid crystal panel 100, first, the second wiring board 30 is connected to the liquid crystal panel 100, and then, the first wiring board 20 is connected to the liquid crystal panel 100. The liquid crystal panel 100 in a state in which the second wiring board 30 is connected is indicated in FIG. 4.

As shown in FIG. 4, one end of the second wiring board 30 is disposed on the element substrate 111 of the liquid crystal panel 100 and is connected to a plurality of second terminals 131 of the second terminal group 130. A driving signal which drives the liquid crystal panel 100 is supplied to the second terminal 131 via the second wiring board 30.

The second wiring board 30 is provided with a base material 31 and a second driving circuit 32 that is provided on the rear surface side of the base material 31. The base material 31 is a substrate that is formed by a deformable material (for example, a film substrate or a flexible substrate) and is a flexible print circuit (FPC) on which a plurality of wires that are not illustrated are formed. The base material 31 is constituted by a first portion 311 and a second portion 312. The first portion 311 is a portion on which the element substrate 111 of the liquid crystal panel 100 is disposed and has a form in which the plurality of wires extend in the Y-axis direction. The second portion 312 is a portion of the base material 31 other than the first portion 311. The second portion 312 includes a portion which is shaped to be bent in the X-axis direction from the Y-axis direction.

The second driving circuit 32 is an integrated circuit (driving IC) that generates and supplies the driving signal to the liquid crystal panel 100. The second driving circuit 32 is electrically and mechanically disposed on a surface on the rear surface side of the second portion 312 of the base material 31 by using a tape automated bonding (TAB) technique, and at least some of the plurality of wires of the base material 31 are connected. The second driving circuit 32 is connected to an upper circuit that is not illustrated. The first driving circuit 22, a third driving circuit 42, and a fourth driving circuit 52 described later have an equal function to the second driving circuit 32 and drive the pixel region 200 that includes data lines of the liquid crystal panel 100 in a shared manner.

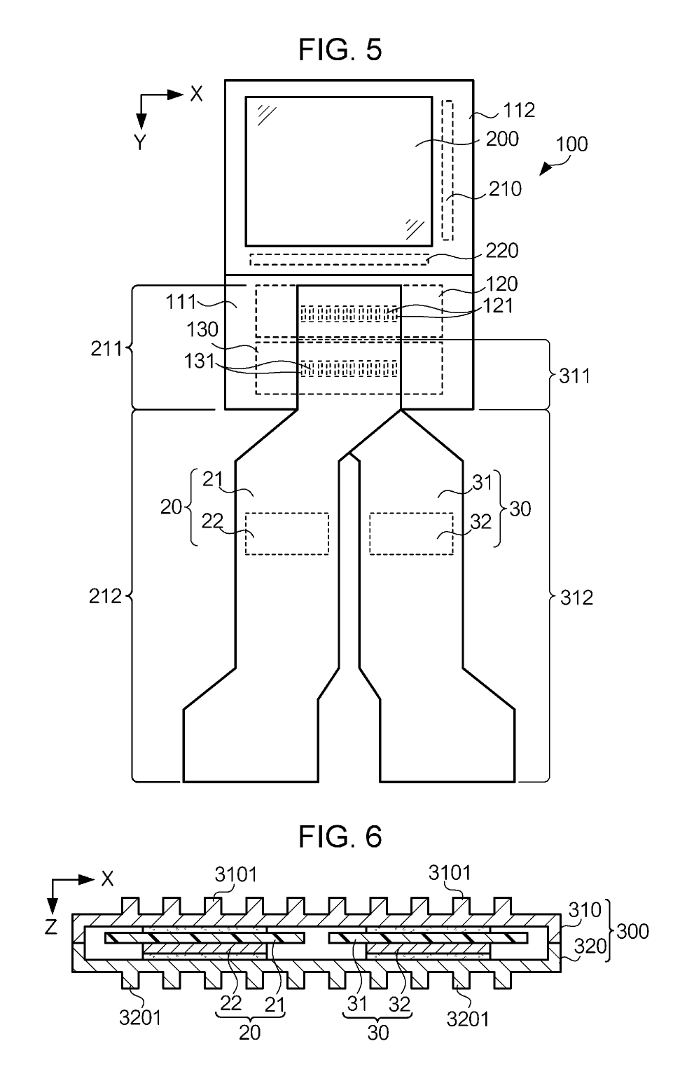

The liquid crystal panel 100 in a state in which the first wiring board 20 and the second wiring board 30 are connected is indicated in FIG. 5. As shown in FIG. 5, one end of the first wiring board 20 is disposed on the element substrate 111 to overlap the second wiring board 30 (here, the first portion 311) and is connected to the plurality of first terminals 121 of the first terminal group 120. A driving signal which drives the liquid crystal panel 100 is supplied to the first terminal 121 via the first wiring board 20.

The first wiring board 20 is provided with a base material 21 and a first driving circuit 22 that is provided on the rear surface side of the base material 21. The configurations of the base material 21 and the first driving circuit 22 are substantially the same with respect to size as the respective base material 31 and the second driving circuit 32 of the second wiring board 30. The base material 21 is constituted by a first portion 211 and a second portion 212, and the first portion 211 is disposed on the element substrate 111 of the liquid crystal panel 100, and the base material 21 has a shape which overlaps a part of the first portion 311 of the base material 31 of the second wiring board 30. The second portion 212 is a part of the base material 21 other than the first portion 211 and is shaped to be bent in a direction different from the second portion 312 of the base material 31 of the second wiring board. In addition, the second portion 212 includes a part that does not overlap the second portion 312 of the base material 31 of the second wiring board. In the embodiment, the second portion 212 of the base material 21 and the second portion 312 of the base material 31 are formed symmetrically about a line in a state of being disposed on the liquid crystal panel 100. The first driving circuit 22 is provided on a surface of the second portion 212, which is on the rear surface side of the portion that does not overlap the second portion 312 of the base material 31 of the second wiring board 30. Therefore, the first driving circuit 22 and the second driving circuit 32 are disposed aligned in the X-axis direction and have no overlap in the Z-axis direction. The heat dissipation member 300 is formed to cover the first driving circuit 22 and the second driving circuit 32.

FIG. 6 is a sectional view (sectional view VI-VI in FIG. 1) when the electro-optical device 1 is cut away along the X-axis. In the cut away part, the first driving circuit 22 is provided on the rear surface of the base material 21 and the second driving circuit 32 is provided on the rear surface of the base material 31. As shown in FIG. 6, the surface on the front surface side of the base material 21 of the first wiring board 20 is fixed to the surface on the rear surface side of the first heat dissipation member 310 by using a fixing agent that has thermal conductivity (hereinafter, simply referred to as “fixing agent”). The fixing agent is, for example, an adhesive or grease. In addition, the surface on the rear surface side of the first driving circuit 22 is fixed to the surface on the front surface side of the second heat dissipation member 320 by using the fixing agent. In the same manner, the surface on the front surface side of the base material 31 of the second wiring board 30 is fixed to the surface on the rear surface side of the first heat dissipation member 310 by using the fixing agent. In addition, the surface on the rear surface side of the second driving circuit 32 is fixed to the surface on the front surface side of the second heat dissipation member 320 by using the fixing agent.

As shown in FIG. 4, the first driving circuit 22 and the second driving circuit 32 are disposed aligned in the X-axis direction and have no overlap in the Z-axis direction. Therefore, the first driving circuit 22 is formed to be covered by the heat dissipation member 300 in both directions of the positive Z-axis direction and the negative Z-axis direction. The first driving circuit 22 faces the second heat dissipation member 320 without interposing an object other than the fixing agent therebetween, and faces the first heat dissipation member 310 without interposing an object other than the base material 21 and the fixing agent therebetween. Therefore, dissipation of heat from the first driving circuit 22 tends not to be hindered by the base material 31 or the second driving circuit 32 of the second wiring board 30, and as a result, it is possible for dissipation of heat of the first driving circuit 22 to be efficient. In the same manner, the second driving circuit 32 also faces the second heat dissipation member 320 without interposing an object other than the fixing agent therebetween, and faces the first heat dissipation member 310 without interposing an object other than the base material 31 and the fixing agent therebetween. Therefore, dissipation of heat from the second driving circuit 32 tends not to be hindered by the base material 21 or the first driving circuit 22 of the first wiring board 20, and as a result, it is possible for dissipation of heat from the second driving circuit 32 to be efficient.

As described above, it is possible to effectively dissipate heat that is generated by each of the first driving circuit 22 on the first wiring board 20 and the second driving circuit 32 on the second wiring board 30.

### Second Embodiment

Next, a second embodiment of the invention will be described. A liquid crystal panel 100A of the second embodiment has a small size and higher definition, for example, having two times the data lines of the liquid crystal panel 100 of the first embodiment (alternatively, two times the number of pixels). Four driving circuits with the same capacity as in the first embodiment are necessary to drive the liquid crystal panel 100A. The second embodiment is different from the first embodiment described above in a point of the number of wiring boards that are connected to the liquid crystal panel being “4”. In the description below, the same reference numerals are given to the same elements as the first embodiment, “A” is given at the end of the reference numerals in the corresponding elements.

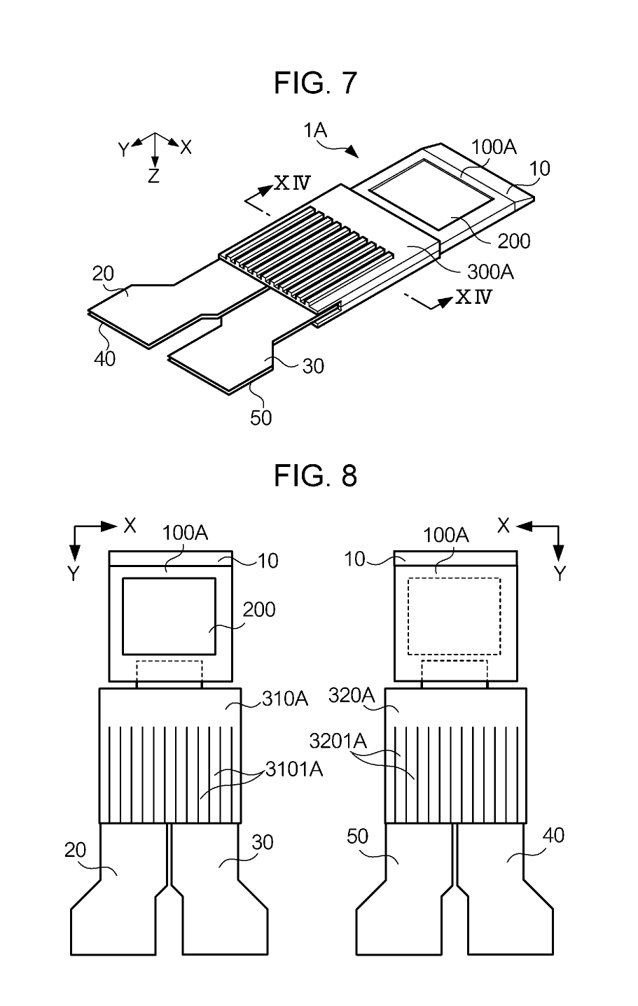

FIG. 7 is a perspective view illustrating a configuration of the electro-optical device 1A according to the second embodiment. FIG. 8 shows a front surface view and a rear surface view of the electro-optical device 1A. The X-axis, the Y-axis, and the Z-axis are specified in the same manner as in the first embodiment described above.

The electro-optical device 1A is provided with the liquid crystal panel 100A, the casing 10, the first wiring board 20, the second wiring board 30, a third wiring board 40, a fourth wiring board 50, and a heat dissipation member 300A. The liquid crystal panel 100A is connected to one end of each of the first wiring board 20, the second wiring board 30, the third wiring board 40, and the fourth wiring board 50. The dispositions of the first wiring board 20 and the second wiring board 30 are the same as in the first embodiment described above. The third wiring board 40 is disposed on the rear surface side of the first wiring board 20. The fourth wiring board 50 is disposed on the rear surface side of the second wiring board 30.

For example, the heat dissipation member 300A is formed using metal, and has a shape that covers a part of the first wiring board 20, the second wiring board 30, the third wiring board 40, and the fourth wiring board 50. The heat dissipation member 300A is provided in order to dissipate heat that is generated in the each wiring board. The heat dissipation member 300A is configured to include a first heat dissipation member 310A that covers each wiring board from the front surface side and a second heat dissipation member 320A that covers each wiring board from the rear surface side. In addition, the heat dissipation member 300A is constituted to cover the first driving circuit 22, the second driving circuit 32, the third driving circuit 42, and the fourth driving circuit 52 that are described later. A plurality of fins 3101A for facilitating heat dissipation are formed on a surface on the front surface side of the first heat dissipation member 310A and a plurality of fins 3201A for facilitating heat dissipation are formed on a surface on the rear surface side of the second heat dissipation member 320A.

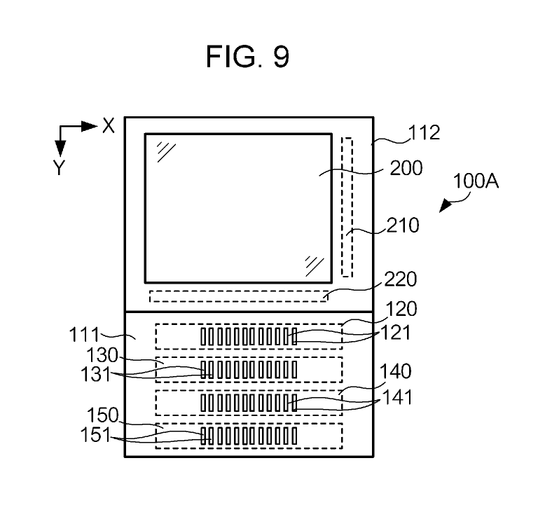

FIG. 9 is a front surface view of the liquid crystal panel 100A. The liquid crystal panel 100A in a state in which the casing 10, the first wiring board 20, the second wiring board 30, the third wiring board 40, the fourth wiring board 50, and the heat dissipation member 300A are removed is indicated in FIG. 9.

In addition to the first terminal group 120 and the second terminal group 130, a third terminal group 140 and a fourth terminal group 150 are formed in the liquid crystal panel 100A.

The third terminal group 140 includes a plurality of third terminals 141 that are arranged in the X-axis direction. The third terminal group 140 is positioned separated further from the pixel region 200 than the second terminal group 130, and in detail, is positioned further on the end portion of the element substrate 111 in the Y-axis direction than the second terminal group 130. The plurality of third terminals 141 include a terminal to which the data signal and the timing signal are input, and are connected to the data line selection circuit 220. At least the plurality of third terminals 141 to which the data signal is input are the same shape and the same dimensions as in the embodiment, and are rectangular viewed in the Z-axis direction. In addition, at least the plurality of third terminals 141 to which the data signal is input are arranged at an equal pitch in the embodiment.

The fourth terminal group 150 includes a plurality of fourth terminals 151 that are arranged in the X-axis direction. The fourth terminal group 150 is positioned separated further from the pixel region 200 than the third terminal group 140, and in detail, is positioned further on the end portion of the element substrate 111 in the Y-axis direction than the third terminal group 140. The plurality of fourth terminals 151 include a terminal to which the data signal and the timing signal are input, and are connected to the data line selection circuit 220. At least the plurality of fourth terminals 151 to which the data signal is input are the same shape and the same dimensions as in the embodiment, and are rectangular viewed in the Z-axis direction. In addition, at least the plurality of fourth terminals 151 to which the data signal is input are arranged at an equal pitch in the embodiment.

In the embodiment, the first terminal group 120, the second terminal group 130, the third terminal group 140, and the fourth terminal group 150 have the same position in the X-axis direction as one set of the first terminal 121, the second terminal 131, the third terminal 141, and the fourth terminal 151.

Note that, the number of terminals that are included in the third terminal group 140 and the fourth terminal group 150 is specified according to the number of data lines and the capacity of the data line selection circuit 220, and the first driving circuit 22 to the fourth driving circuit 52.

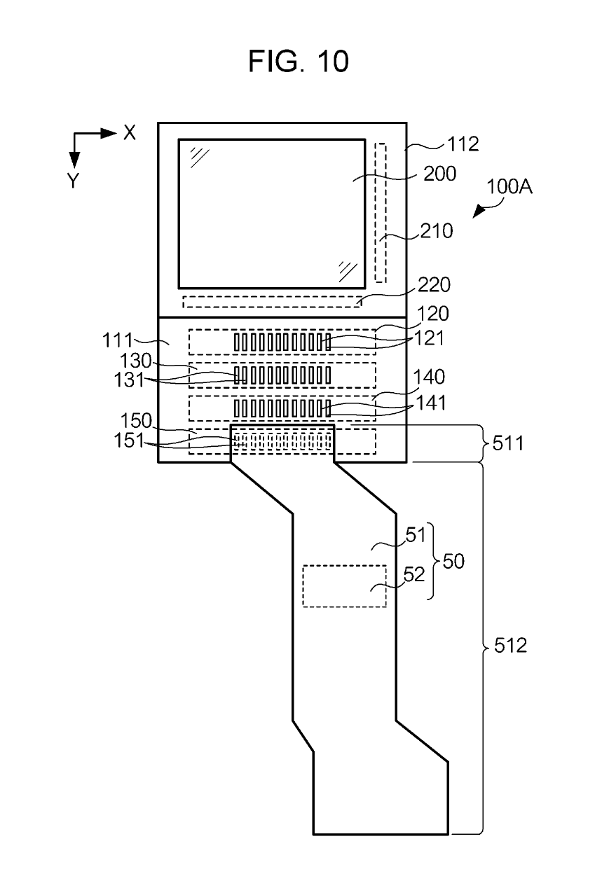

The first wiring board 20 is connected to the plurality of first terminals 121 of the first terminal group 120, the second wiring board 30 is connected to the plurality of second terminals 131 of the second terminal group 130, the third wiring board 40 is connected to the plurality of third terminals 141 of the third terminal group 140, and the fourth wiring board 50 is connected to the plurality of fourth terminals 151 of the fourth terminal group 150. During connection of the liquid crystal panel 100, the fourth wiring board 50, the third wiring board 40, the second wiring board 30, and the first wiring board 20 are connected to the liquid crystal panel 100 in order. The liquid crystal panel 100A in a state in which the fourth wiring board 50 is connected is indicated in FIG. 10.

As shown in FIG. 10, one end of the fourth wiring board 50 is disposed on the element substrate 111, and is connected to the plurality of fourth terminals 151 of the fourth terminal group 150. A driving signal which drives the liquid crystal panel 100A is supplied to the fourth terminal 151 via the fourth wiring board 50.

The fourth wiring board 50 is provided with the base material 51 and the fourth driving circuit 52 that is provided on the base material 51. The configuration of the base material 51 and the fourth driving circuit 52 are substantially the same size as the respective base material 31 and the second driving circuit 32 of the second wiring board 30. The base material 51 is constituted by a first portion 511 and a second portion 512. The first portion 511 is a portion disposed on the element substrate 111 of the liquid crystal panel 100A. The second portion 512 is a portion except for the first portion 511. The second portion 512 includes a part with a shape that is bent in the X-axis direction from the Y-axis direction. The fourth driving circuit 52 is provided on a surface of the base material 51, which is on the rear surface side of the second portion 512.

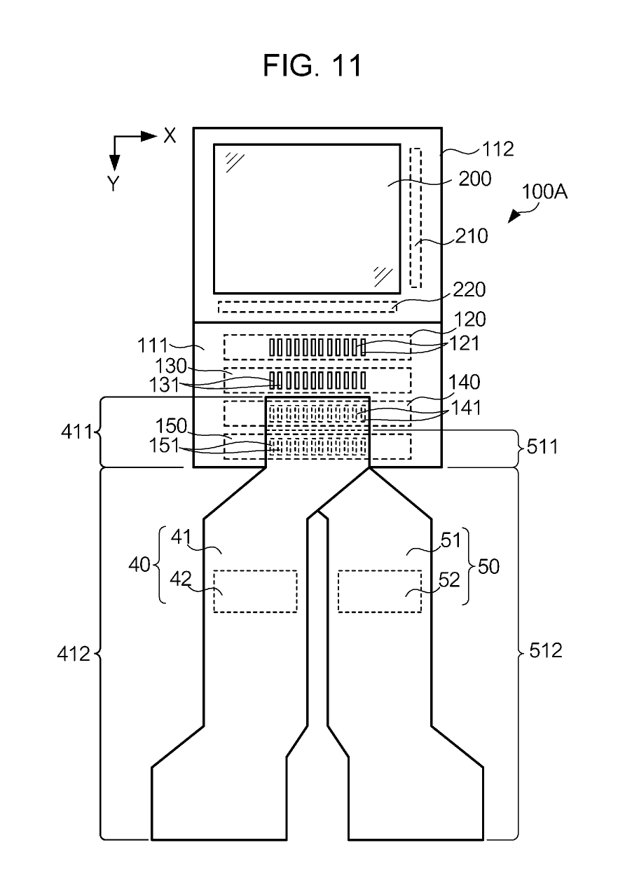

The liquid crystal panel 100A in a state in which the third wiring board 40 and the fourth wiring board 50 are connected is indicated in FIG. 11.

As shown in FIG. 11, one end of the third wiring board 40 is disposed on the element substrate 111 to overlap the fourth wiring board 50 (here, the first portion 511), and is connected to a plurality of third terminals 141 of the third terminal group 140. A driving signal which drives the liquid crystal panel 100A is supplied to the third terminal 141 via the third wiring board 40.

The third wiring board 40 is provided with a base material 41 and a third driving circuit 42 that is provided on the rear surface side of the base material 41. The configuration of the base material 41 and the third driving circuit 42 are substantially the same size as the respective base material 21 and the first driving circuit 22 of the first wiring board 20. The base material 41 is constituted by a first portion 411 and a second portion 412. The first portion 411 is disposed on the element substrate 111 of the liquid crystal panel 100A, and overlaps a part of the first portion 511. The second portion 412 is a portion except for the first portion 411. The second portion 412 has a shape that is bent in the X-axis direction from the Y-axis direction. The third driving circuit 42 is provided on a surface of the base material 41, which is on the rear surface side of the second portion 412. Therefore, the third driving circuit 42 that is provided in the second portion 412 of the third wiring board 40 and the fourth driving circuit 52 that is provided in the second portion 512 of the fourth wiring board 50 are disposed lined up in the X-axis direction, and have no overlap in the Z-axis direction.

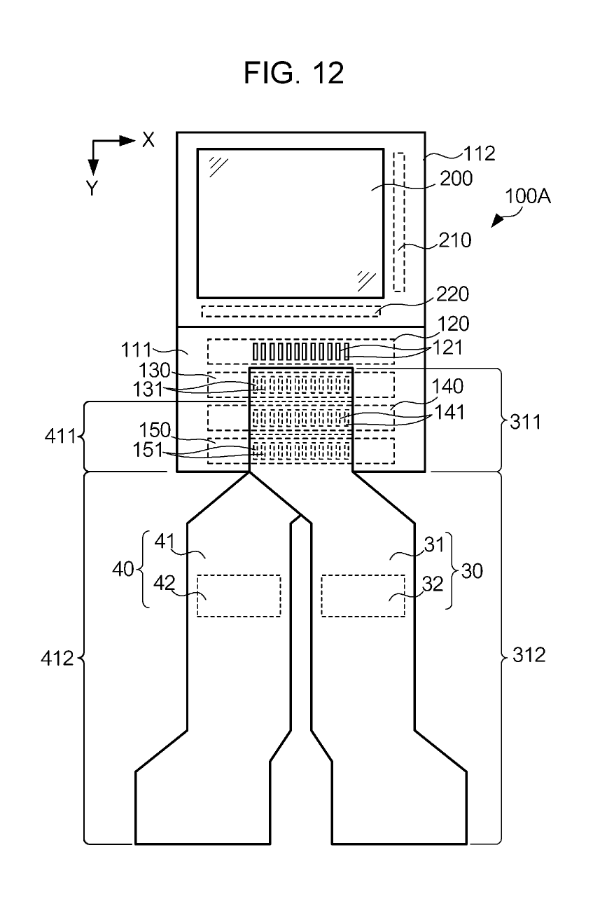

The liquid crystal panel 100A in a state in which the second wiring board 30, the third wiring board 40, and the fourth wiring board 50 are connected is indicated in FIG. 12. The fourth wiring board 50 substantially overlaps the second wiring board 30, therefore illustration is omitted in FIG. 12. As shown in FIG. 12, one end of the second wiring board 30 is disposed on the element substrate 111 to overlap a part of the third wiring board 40 (here first portion 411) and the fourth wiring board 50 (here first portion 511). Here, the second driving circuit 32 is provided on a surface on the rear surface side of the second portion 312 to overlap the fourth driving circuit 52 in the Z-axis direction.

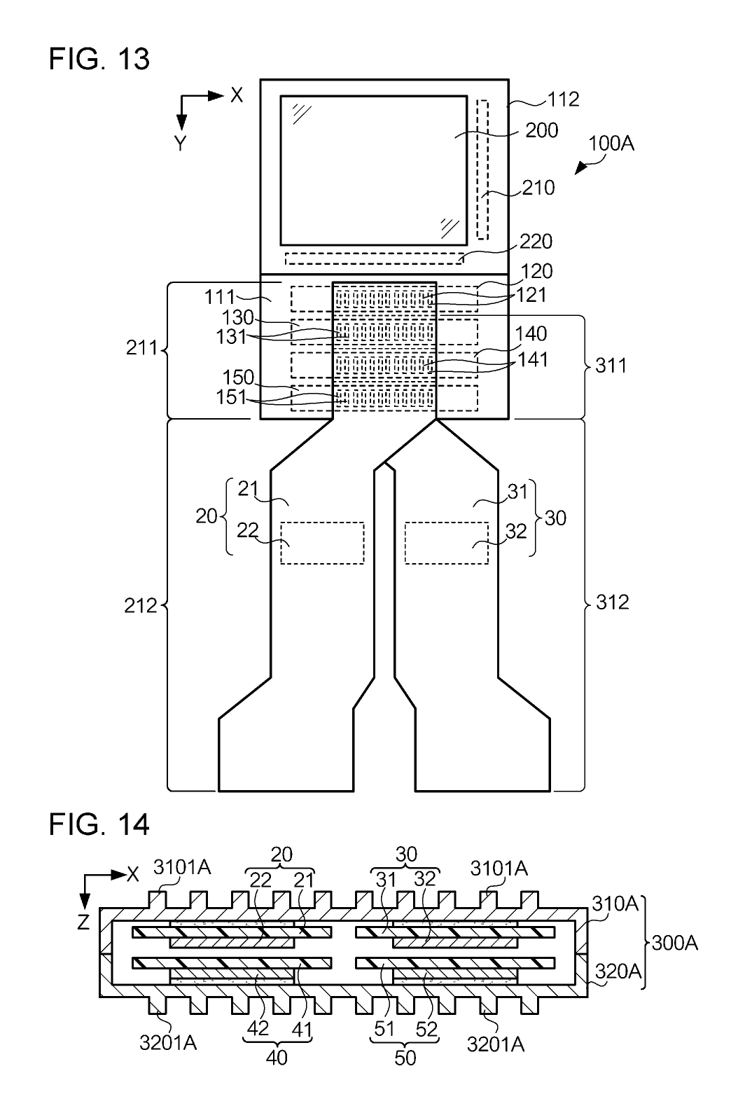

The liquid crystal panel 100A in a state in which the first wiring board 20, the second wiring board 30, the third wiring board 40, and the fourth wiring board 50 are connected is indicated in FIG. 13. The third wiring board 40 and the fourth wiring board 50 each substantially overlap the first wiring board 20 and the second wiring board 30, therefore illustration is omitted in FIG. 13. As shown in FIG. 13, one end of the first wiring board 20 is disposed on the element substrate 111 to overlap a part of the second wiring board 30 (here first portion 311), the third wiring board 40 (here first portion 411), and the fourth wiring board 50 (here first portion 511). Here, the first driving circuit 22 is provided on a surface on the rear surface side of the second portion 212 to overlap the third driving circuit 42 in the Z-axis direction. The heat dissipation member 300A is formed to cover the first driving circuit 22, the second driving circuit 32, the third driving circuit 42, and the fourth driving circuit 52.

FIG. 14 is a sectional view (sectional view XIV-XIV in FIG. 7) when the electro-optical device 1A is cut away along the X-axis. In the cut away part, the first driving circuit 22 to the fourth driving circuit 52 are provided on the rear surface of each of the base material 21 to the base material 51. As shown in FIG. 14, the base material 21 of the first wiring board 20 and the base material 31 of the second wiring board 30 are fixed to the surface on the rear surface side of the first heat dissipation member 310A by using the fixing agent. However, the rear surface side of the first driving circuit 22 and the second driving circuit 32 is not respectively fixed. The third driving circuit 42 of the third wiring board 40 and the fourth driving circuit 52 of the fourth wiring board 50 are fixed to the surface on the front surface side of the second heat dissipation member 320A by using the fixing agent. However, the front surface side of the base material 41 and the base material 51 is not respectively fixed. Therefore, a space (gap) is formed between the first driving circuit 22 and the base material 41 of the third wiring board 40, and a space (gap) is formed between the second driving circuit 32 and the base material 51 of the fourth wiring board 50.

As described already, the base material 21 of the first wiring board 20 and the base material 31 of the second wiring board 30 have shapes bent in directions that are different from each other, and the base material 41 of the third wiring board 40 and the base material 51 of the fourth wiring board 50 have shapes bent in directions that are different from each other. Therefore, the first driving circuit 22 and the second driving circuit 32 are disposed lined up in the X-axis direction. In addition, the third driving circuit 42 and the fourth driving circuit 52 are disposed lined up in the X-axis direction. Furthermore, a space is formed between the first driving circuit 22 and the base material 41 of the third wiring board 40, a space is formed between the second driving circuit 32 and the base material 51 of the fourth wiring board 50, and a path along which the dissipated heat moves is secured. Therefore, it is possible for dissipation of heat of each of the first driving circuit 22, the second driving circuit 32, the third driving circuit 42, and the fourth driving circuit 52 to be efficient.

### Third Embodiment

Next, a third embodiment of the invention will be described. In the third embodiment, a positional relationship of the first driving circuit 22 and the third driving circuit 42 and a positional relationship of the second driving circuit 32 and the fourth driving circuit 52 are different from the second embodiment described above.

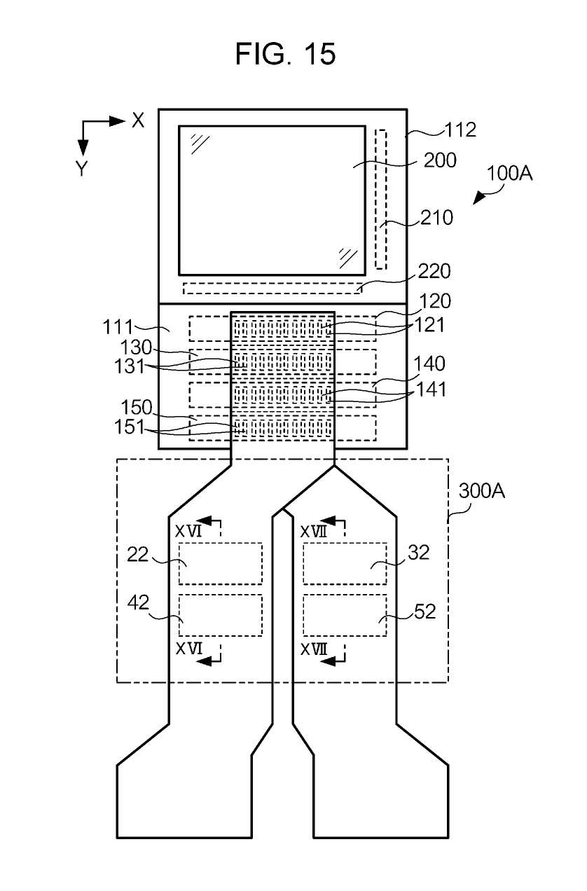

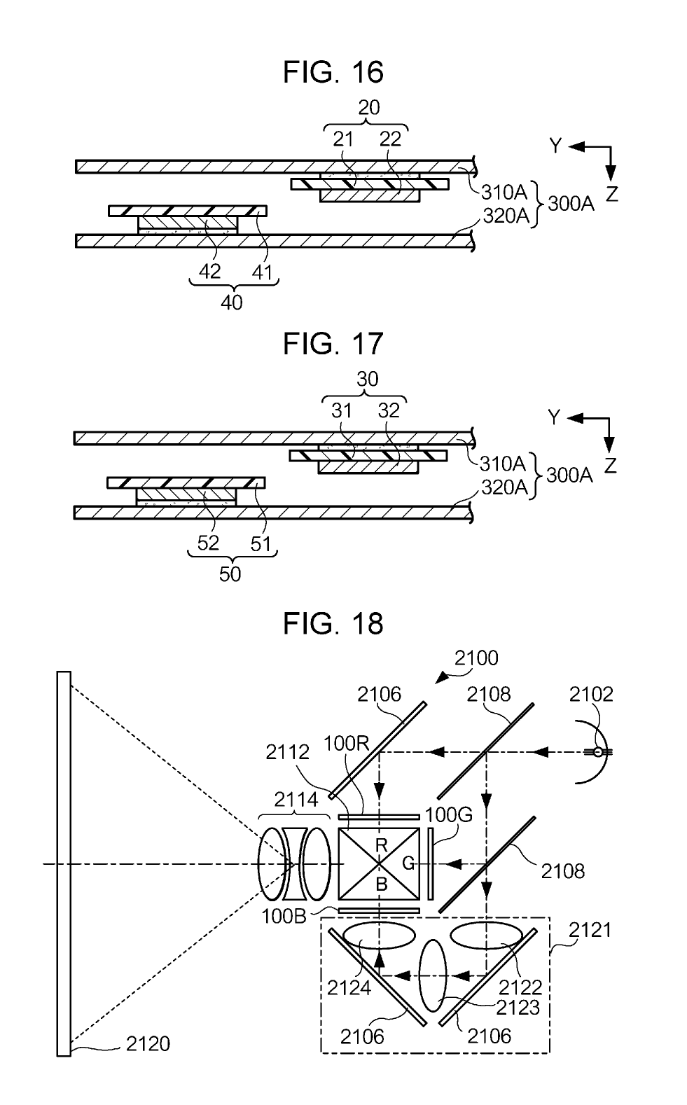

FIG. 15 is a front surface view of the electro-optical device 1A of the embodiment. In FIG. 15, a two-dot chain line indicates a region in which a heat dissipation member 300A is present. FIG. 16 is a sectional view (sectional view XVI-XVI in FIG. 15) when the electro-optical device 1A is cut away along the Y-axis on a plane that includes the first wiring board 20 and the third wiring board 40. FIG. 17 is a sectional view (sectional view XVII-XVII in FIG. 15) when the electro-optical device 1A is cut away along the Y-axis on a plane that includes the second wiring board 30 and the fourth wiring board 50.

As shown in FIGS. 15 and 16, the first driving circuit 22 and the third driving circuit 42 do not overlap in the Z-axis direction with the position deviated in the Y-axis direction. In addition, as shown in FIGS. 15 and 17, the second driving circuit 32 and the fourth driving circuit 52 do not overlap in the Z-axis direction with the position deviated in the Y-axis direction.

Note that, the first driving circuit 22 and the second driving circuit 32 are disposed lined up in the X-axis direction in the same manner as in the second embodiment described above. In addition, the third driving circuit 42 and the fourth driving circuit 52 are disposed lined up in the X-axis direction in the same manner as in the second embodiment described above.

By disposing each driving circuit described in FIGS. 15 to 17, the rear surface side of the first driving circuit 22 faces the second heat dissipation member 320A without interposing the third driving circuit 42, and the front surface side of the third driving circuit 42 faces the first heat dissipation member 310A without interposing the second driving circuit 32. In addition, the rear surface side of the second driving circuit 32 faces the second heat dissipation member 320A without interposing the fourth driving circuit 52, and the front surface side of the fourth driving circuit 52 faces the first heat dissipation member 310A without interposing the second driving circuit 32. Thereby, the path along which the dissipated heat moves is more widely secured than in the configuration of the second embodiment described above. Consequently, it is possible for dissipation of heat of each of the first driving circuit 22, the second driving circuit 32, the third driving circuit 42, and the fourth driving circuit 52 to be efficient.

### Modification Example

The invention is able to be applied in an aspect different from the embodiment described above. In addition, the modification example indicated below may be appropriately combined with each embodiment.

In the embodiment described above, the first wiring board 20 to the fourth wiring board 50 that are connected to the liquid crystal panels 100 and 100A are covered by a heat dissipation member from both sides of the front surface side and the rear surface side. Instead of this, the first wiring board 20 to the fourth wiring board 50 may be configured to be covered by the heat dissipation members 300 and 300A from one side of the front surface side and the rear surface side. In addition, the heat dissipation members 300 and 300A may adopt a configuration to cover at least one wiring board among the first wiring board 20 to the fourth wiring board 50. In addition, the heat dissipation members 300 and 300A may be integrally formed with the casing 10.

In addition, the shapes of each wiring board (base material) are only examples.

In the invention, the terminal group on the element substrate is not limited to two or four, and three or five or more may be provided. In this case, the wiring boards are connected to terminal groups respectively.

The electro-optical panel of the invention may not be a transmissive liquid crystal panel, and for example, may be a reflective liquid crystal panel. In addition, the electro-optical panel of the invention may be a panel that uses an electro-optical element other than liquid crystal such as organic electro-luminescence (EL) if an electro-optical operation is performed.

Next, a projection-type display apparatus (projector) using the liquid crystal panel 100 as a light bulb is described as an example of an electronic apparatus that uses the electro-optical device 1 according to each embodiment described above. FIG. 18 is a planar view illustrating a configuration of the projector.

As shown in FIG. 18, a lamp unit 2102 that consists of a white light source such as a halogen lamp is provided inside a projector 2100. Projected light that is projected from the lamp unit 2102 is separated into three primary colors of R, G, and B using three mirrors 2106 and two dichroic mirrors 2108 that are disposed internally, and are respectively lead to light bulbs 100R, 100G, and 100B that correspond to each primary color. Note that, when compared to R and G, B light has a long light path, therefore in order to prevent loss of light, the B light is led via a relay lens system 2121 that consists of an incident lens 2122, a relay lens 2123, and an emission lens 2124.

In the projector 2100, the electro-optical device 1 that includes the liquid crystal panel 100 to which at least the first wiring board 20 and the second wiring board 30 are connected is provided in three sets that respectively correspond to R, G, and B. The configuration of the light bulbs 100R, 100G, and 100B is the same as the liquid crystal panel 100 described above. A video signal with respective primary color components of R, G, and B is supplied from respective external upper circuits via respective wiring boards, and the light bulbs 100R, 100G, and 100B are configured to be respectively driven. In addition, the electro-optical device 1 is disposed on the projector 2100 such that it is possible to more effectively dissipate heat using the heat dissipation members 300 and 300A.

Light that is respectively modulated by the light bulbs 100R, 100G, and 100B is incident from three directions in a dichroic prism 2112. Then, in the dichroic prism 2112, R and B light is refracted at 90 degrees while G light goes straight. Accordingly, after an image of each primary color is synthesized, a color image is projected by a projection lens 2114 on a screen 2120.

Note that, since light that respectively corresponds to R, G, and B is incident by the dichroic mirrors 2108 to the light bulbs 100R, 100G, and 100B, it is not necessary to provide a color filter. In addition, there is a configuration in which since a transmission image of the light bulb 100G is projected without any changes with respect to transmission images of the light bulbs 100R and 100B being projected after being reflected by the dichroic prism 2112, a horizontal scanning direction by the light bulbs 100R and 100B is a reverse orientation to the horizontal scanning direction by the light bulb 100G and an image that is reflected left and right is displayed.

Other than the projector that is described with reference to FIG. 18, a television, a view finder type/monitor direct view type video tape recorder, a car navigation device, a pager, an electronic diary, an electronic calculator, a word processor, a workstation, a video phone, a POS terminal, a digital still camera, a mobile phone, a smartphone, a tablet type terminal, another device that is provided with a touch panel, and the like are given as the electronic apparatus. Then, the electro-optical device 1 is able to be applied to the various electronic apparatus.

The entire disclosure of Japanese Patent Application No. 2016-146025, filed Jul. 26, 2016 is expressly incorporated by reference herein.

What is claimed is:

1. An electro-optical device comprising:
an electro-optical panel;
a first wiring board, a first end of which is connected to the electro-optical panel;
a second wiring board, a second end of which is connected to the electro-optical panel at a position in a first direction from the first end, the second wiring board has a first portion and a second potion, the second potion has a bent part in a second direction that is different from the first direction;
a first driving circuit that is provided on the first wiring board and drives the electro-optical panel; and
a second driving circuit that is provided in the second potion and drives the electro-optical panel.

2. The electro-optical device according to claim 1, further comprising;
a heat dissipation member that is disposed at a position which covers the first driving circuit and the second driving circuit.

3. The electro-optical device according to claim 2,
wherein the heat dissipation member is disposed at a position which covers the first driving circuit and the second driving circuit from one surface side and the other surface side of the first wiring board and the second wiring board.

4. The electro-optical device according to claim 1, further comprising;
a third driving circuit that is provided at a position not overlapping the first driving circuit on the first wiring board and that drives the electro-optical panel; and
a fourth driving circuit that is provided at a position not overlapping the second driving circuit on the bent part and that drives the electro-optical panel.

5. An electronic apparatus comprising:
the electro-optical device according to claim 1.

6. An electronic apparatus comprising:
the electro-optical device according to claim 2.

7. An electronic apparatus comprising:
the electro-optical device according to claim 3.

8. An electronic apparatus comprising:
the electro-optical device according to claim 4.

9. An electro-optical device comprising:
an electro-optical panel;
a first wiring board that is connected to a first terminal of the electro-optical panel;
a second wiring board that is connected to a second terminal of the electro-optical panel at a position in a first direction viewed from the first terminal of the first wiring board;
a first driving circuit that is provided on the first wiring board; and
a second driving circuit that is provided on the second wiring board,
wherein the second wiring board is shaped to be bent in a second direction that is different from the first direction, and
the first driving circuit and the second driving circuit do not overlap in planar view.
